(19) United States
(12) Patent Application Publication
(10) Pub. No.: US 2025/0085187 A1
(43) Pub. Date: Mar. 13, 2025

(54) SOUNDNESS EVALUATION APPARATUS, SOUNDNESS EVALUATION METHOD, AND COMPUTER-READABLE RECORDING MEDIUM

(71) Applicant: NEC CORPORATION, Minato-ku, Tokyo (JP)

(72) Inventors: Kosuke KINOSHITA, Tokyo (JP); Yuki YAMAGUCHI, Tokyo (JP); Taichi TANAKA, Tokyo (JP); Takahiro KUMURA, Tokyo (JP)

(73) Assignee: NEC CORPORATION, Minato-ku, Tokyo (JP)

(21) Appl. No.: 18/725,875

(22) PCT Filed: Jan. 13, 2022
(86) PCT No.: PCT/JP2022/000986

§ 371 Date: Jul. 1, 2024

(51) Int. Cl. G01M 5/00

(52) U.S. Cl. CPC G01M 5/0041; G01M 5/0008

(57) ABSTRACT

A soundness evaluation apparatus including: a selection unit selects, from pieces of displacement information indicating displacement amounts of a plurality of measurement points included in a region including a structural object, displacement information regarding a range set in the structural object, based on a preset period and the range; a calculation unit calculates an index representing a correlation based on the displacement information regarding the range in the period and environmental information indicating a state of an environment surrounding the range; and a generation unit generates a determination condition to be used for evaluating soundness of the structural object based on a plurality of the calculated indices.

### TECHNICAL FIELD

The technical field relates to a soundness evaluation apparatus and a soundness evaluation method for diagnosing soundness of a structure, and further relates to a computer-readable recording medium having recorded thereon a program for realizing the apparatus and method.

### BACKGROUND ART

The service life of structural objects such as bridges is generally said to be about 50 years. However, many of the structural objects were constructed all together in the high growth period (1960s), and the service life thereof has expired. Therefore, the soundness of many of the structural objects needs to be evaluated.

As related techniques, a system for evaluating the soundness of a structural object based on displacement of the structural object is disclosed in Patent Document 1. According to the system of Patent Document 1, raw displacement amounts of observation points set in a structural object are calculated using positioning satellites, corrected displacement amounts are calculated by removing temperature correction values from the raw displacement amounts, and the soundness of the structural object to be evaluated is evaluated in a stepwise manner according to the corrected displacement amounts.

Note that if the displacement of a structural object to be evaluated is caused by thermal expansion/contraction, the corrected displacement amounts take very small values, and the structural object is regarded as sound. Conversely, if the corrected displacement amounts take large values, the displacement of a structural object to be evaluated includes displacement due to other factors rather than the thermal expansion/contraction, and the structural object is not regarded as sound.

### LIST OF RELATED ART DOCUMENTS

### Patent Document

Patent Document 1: Japanese Patent Laid-Open Publication No. 2021-117007

### SUMMARY OF INVENTION

### Problems to be Solved by the Invention

However, in the system disclosed in Patent Document 1, the threshold values to be used to evaluate the soundness in a stepwise manner need to be appropriately set by a user in advance. If the threshold values are not appropriate, the soundness of a structural object cannot be accurately evaluated with the system.

Therefore, an object is to provide a soundness evaluation apparatus and a soundness evaluation method with which the soundness of a structural object can be evaluated, and a computer-readable recording medium.

### Means for Solving the Problems

In order to achieve the example object described above, a soundness evaluation apparatus according to an example aspect includes:
a selection unit selects, from pieces of displacement information indicating displacement amounts of a plurality of measurement points included in a region including a structural object, displacement information regarding a range set in the structural object, based on a preset period and the range;
a calculation unit calculates an index representing a correlation based on the displacement information regarding the range in the period and environmental information indicating a state of an environment surrounding the range; and
a generation unit generates a determination condition to be used for evaluating soundness of the structural object based on a plurality of the calculated indices.

Also, in order to achieve the example object described above, a soundness evaluation method that is performed by a computer according to an example aspect includes:
selecting, from pieces of displacement information indicating displacement amounts of a plurality of measurement points included in a region including a structural object, displacement information regarding a range set in the structural object, based on a preset period and the range;
calculating an index representing a correlation based on the displacement information regarding the range in the period and environmental information indicating a state of an environment surrounding the range; and
generating a determination condition to be used for evaluating soundness of the structural object based on a plurality of the calculated indices.

Furthermore, in order to achieve the example object described above, a computer-readable recording medium according to an example aspect includes a program recorded on the computer-readable recording medium, the program including instructions that cause the computer to carry out:
selecting, from pieces of displacement information indicating displacement amounts of a plurality of measurement points included in a region including a structural object, displacement information regarding a range set in the structural object, based on a preset period and the range;
calculating an index representing a correlation based on the displacement information regarding the range in the period and environmental information indicating a state of an environment surrounding the range; and
generating a determination condition to be used for evaluating soundness of the structural object based on a plurality of the calculated indices.

### Advantageous Effects of the Invention

In one aspect, according to the soundness evaluation apparatus and the like, the soundness of a structural object can be accurately evaluated.

### BRIEF DESCRIPTION OF THE DRAWINGS

FIG. 1 is a diagram for describing an example of the soundness evaluation apparatus.

FIG. 2 is a diagram for describing an exemplary system including the soundness evaluation apparatus.

FIG. 3 is a diagram for describing the relationship between the bridge and measurement points.

FIG. 4 is a box-and-whisker plot showing displacement amounts of measurement points included in the set range.

FIG. 5 is a diagram for describing relationships between the selected range and similar ranges, in the method (1).

FIG. 6 is a box-and-whisker plot illustrating the correlation between the displacement amount and the temperature difference.

FIG. 7 is a diagram for describing an exemplary display in the method (1).

FIG. 8 is a diagram for describing a range of a similar bridge in the method (2).

FIG. 9 is a diagram for describing the relationship between a similar bridge and measurement points in the method (2).

FIG. 10 is a diagram for describing an exemplary display in the method (2).

FIG. 11 is a diagram for describing the plurality of different periods in the method (3).

FIG. 12 is a diagram for describing an exemplary display in the method (3).

FIG. 13 is a diagram for describing a specific example of the function approximation.

FIG. 14 is a diagram illustrating an example of the operations of the soundness evaluation apparatus of the example embodiment.

FIG. 15 is a diagram for describing an example of a computer that realizes the soundness evaluation apparatus in the example embodiment.

### EXAMPLE EMBODIMENT

First, an outline will be described for facilitating understanding of the example embodiment described below. When evaluating soundness of a bridge, a plurality of sensors are installed in the bridge, and the soundness of the bridge is evaluated based on measurement data of the plurality of installed sensors. For example, if the measurement data itself or some index calculated using the measurement data satisfies a determination condition, the target bridge is evaluated to be sound.

In order to evaluate soundness of a bridge, an evaluation criterion, that is, a determination condition is needed. However, currently, the evaluation criterion cannot be easily determined.

The reason is that the sensors (fixed sensors) such as an acceleration sensor, a strain sensor, an image sensor, and an infrared ray sensor cannot be easily installed in a bridge. Also, the installation cost of a fixed sensor, and the maintenance and inspection cost after installation cost become expensive.

Also, in order to determine the evaluation criterion, many pieces of measurement data (sample data) are needed, however, currently measurement data can only be acquired from specific positions of a very small number of bridges in which fixed sensors were able to be installed. As a result, an accurate evaluation criterion (determination condition) cannot be determined.

Therefore, accurate soundness evaluation cannot be performed on a bridge in which no fixed sensor is installed and whose service life has expired, and even with respect to positions (members), of a same bridge, at which no fixed sensor is installed.

Soundness evaluation using positioning satellites has been proposed as another soundness evaluation. With the measurement using the positioning satellites, measurement data can be acquired not only at a specific position, but also at a plurality of measurement points over a wide range including the specific position of a bridge. Moreover, measurement data on a plurality of measurement points over a wide range can be acquired with respect to a bridge other than the bridge to be evaluated.

However, a bridge is influenced by an environment surrounding the bridge (e.g., temperature, insolation amount, and the like), and therefore, even if positioning satellites are used, environmental influence is included in the measurement data. Therefore, the environmental influence needs to be removed from the measurement data.

Through such a process, the inventors have found out a problem of automatically generating a determination condition used for soundness evaluation, and have derived a means for solving the problem.

That is, the inventors have derived a means for automatically generating a determination condition used for evaluating soundness of a structural object such as a bridge. As a result, evaluation of soundness of a structural object such as a bridge can be easily performed.

In addition, although soundness evaluation should not be easily influenced by noise, noise components such as those due to positioning satellites and temperature are included in measurement data, and therefore a countermeasure to such noise components has also been a problem. The inventors focused on this problem, and have derived a means for evaluating soundness while reducing the influence of noise components.

Hereinafter, an example embodiment will be described with reference to the drawings. Note that, in the drawings described below, the elements that have the same or corresponding functions are given the same reference numerals and description thereof may not be repeated.

### Example Embodiment

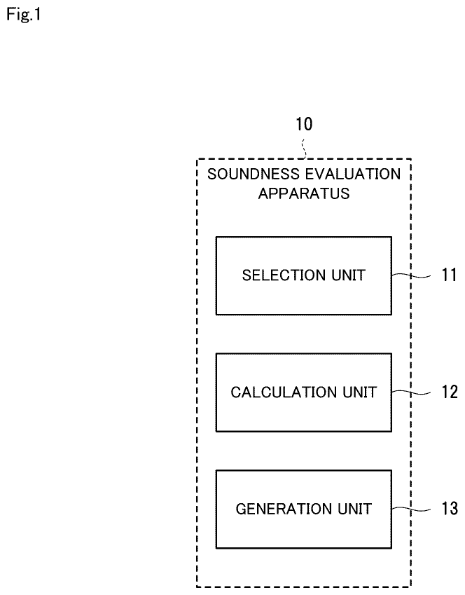

The configuration of a soundness evaluation apparatus 10 in the example embodiment will be described using FIG. 1. FIG. 1 is a diagram for describing an example of the soundness evaluation apparatus.

### [Apparatus Configuration]

The soundness evaluation apparatus 10 shown in FIG. 1 is an apparatus for evaluating soundness of a structural object. Also, as shown in FIG. 1, the soundness evaluation apparatus 10 includes a selection unit 11, a calculation unit 12, and a generation unit 13.

The structural object is a structural object constructed using a hardened material (concrete, mortar, or the like) solidified at least using sand, water, and cement, or a metal, or a combination of these. The structural object is a bridge or the like, for example. Also, the structural object is the entirety or a portion of a building. Moreover, the structural object is the entirety or a portion of machinery.

The selection unit 11 selects, from pieces of displacement information indicating displacement amounts of a plurality of measurement points included in a region including the structural object, pieces of displacement information regarding a range set in the structural object, based on a preset period and the set range.

The plurality of times are times at which measurement data was acquired by remote sensing. In the remote sensing, measurement data is acquired using a synthetic aperture radar (SAR), for example.

The SAR emits a microwave from an antenna mounted on a flying object such as an artificial satellite or an aircraft toward the ground, and generates measurement data (SAR image) using a reflected wave from a structural object to be measured.

The displacement information is information indicating a displacement amount obtained by executing interferometric processing using phase information included in a pair of SAR images captured at two times.

Specifically, the displacement amount is calculated by performing interferometric processing on a pair of SAR images, namely a SAR image of a region including the structural object generated at a preset reference time t0 and a SAR image of the region including the structural object generated at a preset time tn.

The reference time t0 is a time at which the structural object was completed, a time at which the structural object is regarded as normal, or the like, for example. Times tn (n=1, 2, 3, . . . ) are times different from the reference time t0. It is conceivable that the interval of times tn is set to a period from two weeks to three months, for example.

For example, the displacement amount at time t1 is estimated using a pair of a SAR image at the reference time t0 and a SAR image at time t1 (time after the reference time t0). Similarly, the displacement amount at time tn is calculated using a pair of a SAR image at the reference time t0 and a SAR image at time tn.

The range is set in advance by a user that performs soundness evaluation. In the case of a bridge, for example, it is conceivable that the range is set at a center of a bridge superstructure that is arranged between bridge piers. Alternatively, it is conceivable that the range is set to a range including a fixed point whose displacement is considered to be small in terms of the design.

The period is set in advance by a user that performs soundness evaluation. The period includes a plurality of times at which measurement data was acquired. Note that a plurality of times may also be set as a period.

The calculation unit 12 calculates an index representing the correlation based on displacement information regarding a preset range in a preset period and environmental information representing the state of an environment surrounding the preset range.

When the calculation unit 12 calculates the index, the displacement information regarding a preset range in a preset period may be used as is, or corrected displacement information obtained by correcting the displacement information by performing approximation using a mathematical model may also be used.

In the description below, description will be given assuming that the calculation unit 12 calculates the index using the displacement information as is. An example in which the corrected displacement information is used will be described later.

The environmental information is information representing a past temperature, a precipitation amount, a snowfall amount, an insolation amount, and the like in the range or a surrounding area thereof, or in an area at which the structural object is located or a surrounding area thereof. Also, information representing an altitude, a distance from a coastline, a distance from a river, and the like may also be added to the environmental information.

The index is a correlation coefficient that is calculated using displacement information, at each time, regarding measurement points included in the selected range and the environmental information.

Regarding the correlation coefficient, when the temperature is used, for example, the correlation coefficient is calculated using displacement information (displacement amount) regarding a measurement point and a temperature difference in the selected range as variables. The correlation coefficient is a numerical value, a level, or the like that represents the degree of relationship between the displacement amount and the temperature difference, for example.

The temperature differences ksn (n=1, 2, 3, . . . ) are differences between a temperature k0 at a reference time t0 and temperatures kn (n=1, 2, 3, . . . ) at respective set times tn (n=1, 2, 3, . . . ). For example, the temperature difference ks1 at time t1 can be calculated by k1−k0.

Note that regarding the precipitation amount, snowfall amount, and insolation amount as well, the correlation coefficients are calculated using displacement amounts and differences in precipitation amount, displacement amounts and differences in snowfall amount, and displacement amounts and differences in insolation amount.

In the case of a precipitation amount, the correlation coefficient is a numerical value, a level, or the like that represents the degree of relationship between the displacement amount and the difference in precipitation amount. Also, in the case of a snowfall amount, the correlation coefficient is a numerical value, a level, or the like that represents the degree of relationship between the displacement amount and the difference in snowfall amount, for example. Also, in the case of an insolation amount, the correlation coefficient is a numerical value, a level, or the like that represents the degree of relationship between the displacement amount and the difference in insolation amount, for example.

The generation unit 13 generates a determination condition to be used for evaluating soundness of a structural object based on a plurality of calculated indices. Specifically, the generation unit 13 calculates the determination condition with one of the following methods (1), (2), and (3).
(1) Statistical values (e.g., average value, variance value, and the like) are calculated using indices in other ranges, of the same structural object, that have a structure similar to the range set in the structural object, and the determination condition is calculated using the calculated statistical values.
(2) Statistical values (e.g., average value, variance value, and the like) are calculated using indices in ranges, of another structural object, that have a structure similar to the range set in the structural object, and the determination condition is calculated using the calculated statistical values.
(3) Statistical values (e.g., average value, variance value, and the like) are calculated using indices corresponding to a plurality of different periods, and the determination condition is calculated using the calculated statistical values.

In any of the cases of the methods (1), (2), and (3), the generation unit 13 generates the determination condition using the statistical values of indices. The determination condition is favorably a condition in which an upper limit and a lower limit of the value range that a normal correlation coefficient may take are set using an average value and a standard deviation of the index, and if the index is out of the value range, it is regarded as abnormal, for example.

For example, the upper limit and lower limit of the index value range may be set as “average value±1.5×standard deviation”. This is a determination condition based on a confidence interval, which is a concept of statistics. The condition can be adjusted using the numerical value of 1.5. Note that the determination condition is not limited to the example described above.

As described above, in the example embodiment, the determination condition to be used for soundness evaluation is generated with the methods (1), (2), and (3). Also, because many pieces of displacement information and environmental information can be acquired from a large number of structural objects, an accurate determination condition can be generated.

### [System Configuration]

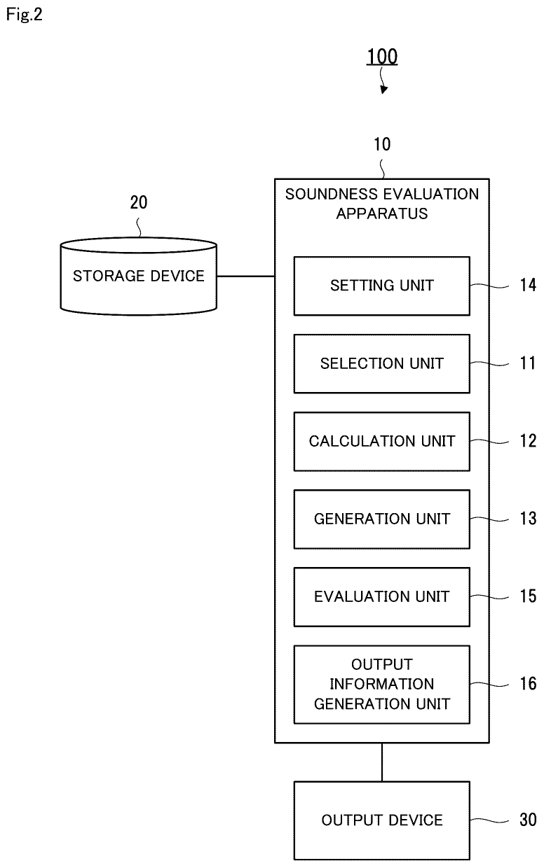

Next, the configuration of the soundness evaluation apparatus 10 in the example embodiment will be more specifically described using FIG. 2. FIG. 2 is a diagram for describing an exemplary system including the soundness evaluation apparatus.

As shown in FIG. 2, a system 100 in the example embodiment includes a soundness evaluation apparatus 10, a storage device 20, and an output device 30. The soundness evaluation apparatus 10 in FIG. 2 includes a setting unit 14, a selection unit 11, a calculation unit 12, a generation unit 13, an evaluation unit 15, and an output information generation unit 16.

The soundness evaluation apparatus 10 is a CPU (Central Processing Unit), a programmable device such as an FPGA (Field-Programmable Gate Array), or a GPU (Graphics Processing Unit), or a circuit on which at least one of the devices is mounted, or an information processing apparatus such as a server computer, a personal computer, or a mobile terminal.

The storage device 20 stores at least measurement data (e.g., SAR images and the like), measurement point information (e.g., information including measurement point identification information, measurement point position information, displacement information, and the like), setting information representing a range set by a user (range represented by latitude, longitude, and altitude) and times, environmental information, indices (e.g., correlation coefficient and the like), a determination condition (evaluation criterion), structure information representing structures of a plurality of structural objects (e.g., information including structure identification information, structure position information, structure style information, material type information, member identification information, structure dimension information, member dimension information, member position information, and the like).

The storage device 20 is a database, a server computer, a circuit including a memory, a device including a memory, or the like. Note that, in the example in FIG. 2, the storage device 20 is provided outside of the soundness evaluation apparatus 10, but may also be provided inside the soundness evaluation apparatus 10.

The output device 30 acquires later-described output information that is converted, by the output information generation unit 16, into a format that can be output, and outputs images, audio and the like generated based on this output information. The output device 30 is an image display device that uses liquid crystal, organic EL (ElectroLuminescence) or a CRT (Cathode Ray Tube). Furthermore, the image display device may include an audio output device such as a speaker, and the like. Note that the output device 30 may also be a printing device such as a printer.

The soundness evaluation apparatus of the example embodiment will be described in detail.

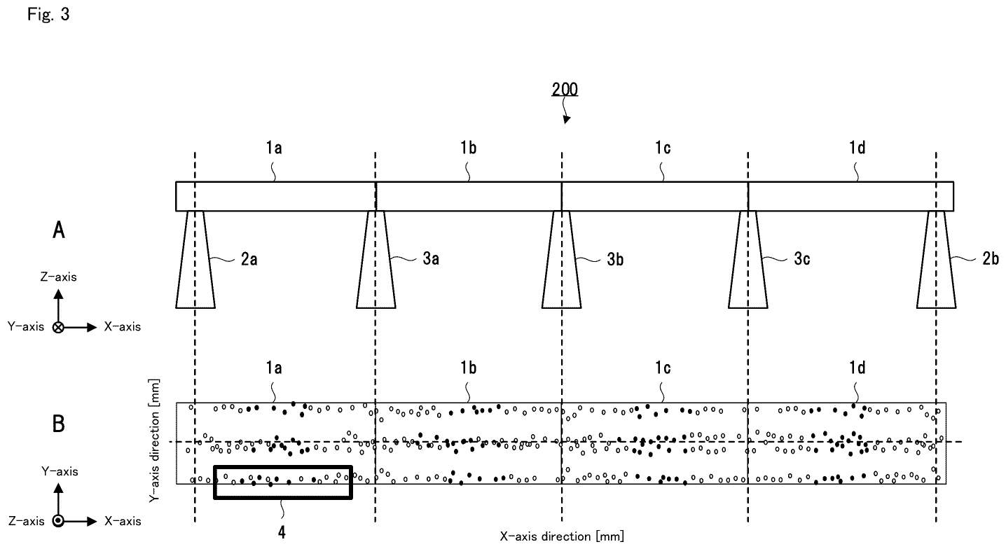

A case where the structural object is a bridge will be described below. FIG. 3 is a diagram for describing the relationship between the bridge and measurement points. A in FIG. 3 is a side view illustrating the structure of the bridge 200 subjected to soundness evaluation. In the example in A in FIG. 3, the structure of the bridge 200 is illustrated using superstructures 1a, 1b, 1c, and 1d, abutments 2a and 2b, and bridge piers 3a, 3b, and 3c, for the sake of description.

B in FIG. 3 is a top view illustrating a plurality of measurement points (0: circles) when the bridge 200 was measured using SAR. Also, each measurement point is associated with measurement point information. In the measurement point information, measurement point identification information for identifying the measurement point, measurement point position information representing the measurement point position (latitude, longitude, and altitude), and displacement information representing the displacement amount [mm] obtained from phase information included in SAR images are associated.

The soundness evaluation apparatus 10 generates a determination condition with the method (1), (2), or (3) described above. With the method (1), the soundness evaluation apparatus 10 calculates statistical values using indices of other ranges, of the same structural object, having a structure similar to a range 4 set in the bridge 200, and generates a determination condition using the calculated statistical values.

Also, with the method (2), the soundness evaluation apparatus 10 calculates statistical values using indices of ranges, of other structural objects, that have a structure similar to the range 4 set in the structural object 200, and generates a determination condition using the calculated statistical values.

Also, with the method (3), the soundness evaluation apparatus 10 calculates statistical values (e.g., average value, variance value, and the lie) using indices corresponding to a plurality of different periods, in the range 4 set in the structural object 200, and generates a determination condition using the calculated statistical values.

The method (1) will be described in detail.

The setting unit 14 sets a bridge 200 to be subjected to soundness evaluation, a range 4, of the bridge 200, that is subjected to soundness evaluation, a reference time t0, at least one period (including a plurality of times) to be subjected to soundness evaluation, and a range of the bridge 200, that is different from the range 4 and has a structure similar to the structure of the range 4. Specifically, the setting unit 14 stores setting information indicating the settings described above in the storage device 20.

A user that performs soundness evaluation sets a bridge 200 to be evaluated, and a range 4. Also, the user that performs soundness evaluation sets a reference time t0, a period in which the soundness evaluation is performed, and a different range that has a structure similar to the structure of the range 4 (hereinafter, may be simply denoted as a different range 5).

The user sets the range 4 and the different range 5 using an input device (not illustrated) by referring to display such as a side view (A in FIG. 3) or a top view (B in FIG. 3) of the bridge 200 shown in FIG. 3, which is displayed in the output device 30.

In the example in B in FIG. 3, the range of the range 4 is determined using latitudes, longitudes, and altitudes of four points of a rectangle. Also, the range of the different range is determined using latitudes, longitudes, and altitudes of four points of a rectangle. Note that the shape of the range is not limited to a rectangle.

The selection unit 11 selects pieces of displacement information regarding the range 4 and the different range 5 based on a preset period, the range 4, and the different range 5, from pieces of displacement information indicating displacement amounts of a plurality of measurement points included in a region including the bridge 200.

Note that when a plurality of different periods are set, pieces of displacement information regarding the range 4 and the different range 5 are selected for each period. The plurality of different periods includes the period subjected to soundness evaluation and periods prior to the period to be evaluated.

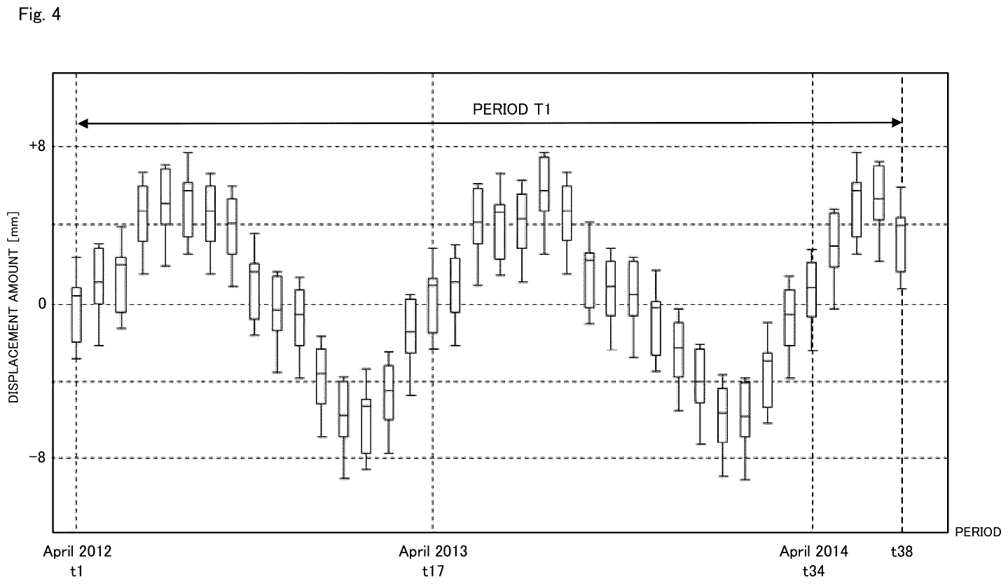

FIG. 4 is a box-and-whisker plot showing displacement amounts of measurement points included in the set range. In the example in FIG. 4, the displacement amounts of a plurality of measurement points included in the range 4 that correspond to each of times t1 to t38 included in a set period T1 are shown.

The displacement amount in April 2012 in FIG. 4 shows displacement amounts of the plurality of measurement points included in the range 4 that are obtained by executing interferometric processing using a SAR image of the range 4 that is generated at a reference time t0 (time prior to April 2012) and a SAR image of the range 4 that is generated at time t1 in April 2012.

The different range 5, of the same bridge 200, that has a structure similar to the structure of the range 4 and is different from the range 4 will be described. The range 4 and the different range 5 are set by a user based on structure information.

The structure information is information in which structure identification information for identifying a structural object (e.g., name, identifier, or the like), structure position information indicating the position at which the structural object is present (e.g., latitude, longitude, and altitude, and the like), structure style information indicating the style of the structural object, material type information indicating the types of materials used in the structural object, member identification information for identifying members that constitute the structural object, structure dimension information indicating dimensions of the structural object, member dimension information indicating dimensions of the members, member position information indicating the positions of the members used in the structural object (e.g., latitude, longitude, and altitude, and the like), and the like are associated.

A case of a bridge will be described. The structure identification information is information indicating a name, an identifier, or the like of the bridge, for example. The structure position information is information indicating a region, a position (latitude, longitude, and altitude), or the like at which the bridge is present, for example. The material type information is information obtained by classifying the bridge based on the material used in the bridge, such as a wooden bridge, a stone bridge, a steel bridge, a concrete bridge, a composite bridge, or the like, for example.

The structure style information is information indicating the style of the bridge, such as a girder bridge, a truss girder bridge, an arch bridge, a rigid frame bridge, a suspension bridge, a cable stayed bridge, or the like, for example. The style may also be subdivided in the structure style information.

The member identification information is information indicating the type such as a floor slab, a main girder, a cross beam, a sway bracing, a lateral bracing, a bearing (fixed bearing, operating bearing), an expansion joint, bridge fall prevention equipment, a superstructure, an abutment, a bridge pier, or the like, for example. The type may also be subdivided in the member identification information.

The structure dimension information is information indicating the dimensions of the bridge such as a bridge length, an effective span, a span length, a clear span, and the like, for example. The member dimension information is information indicating the dimensions of the aforementioned members and the like, for example.

Also, information indicating a gravity type, an inverse T type, a parapet type, a rigid frame type, a box type, or the like may also be added to the structure information, for example, as information indicating the type of abutment (building frame). Moreover, information indicating a vertical wall, a footing, a pile foundation, a wing, a parapet, or the like may also be added to the structure information, for example, as information indicating the members that constitute the abutment (building frame).

Also, information indicating an overhang type, a wall type, a rigid frame type, a pillar type, or the like may also be added to the structure information, for example, as information indicating the type of the bridge pier (building frame). Moreover, information indicating a beam, a pillar section, a footing, a pile foundation, a caisson foundation, or the like may also be added to the structure information, for example, as information indicating the members that constitute the bridge pier (building frame).

Also, information indicating a road surface position (through, half-through, deck), information indicating the type of the cross-sectional shape of the girder (I girder, box girder, T girder), and information indicating a girder connection (continuous girder, simple girder, Gerber structure) and the like may also be added to the structure information.

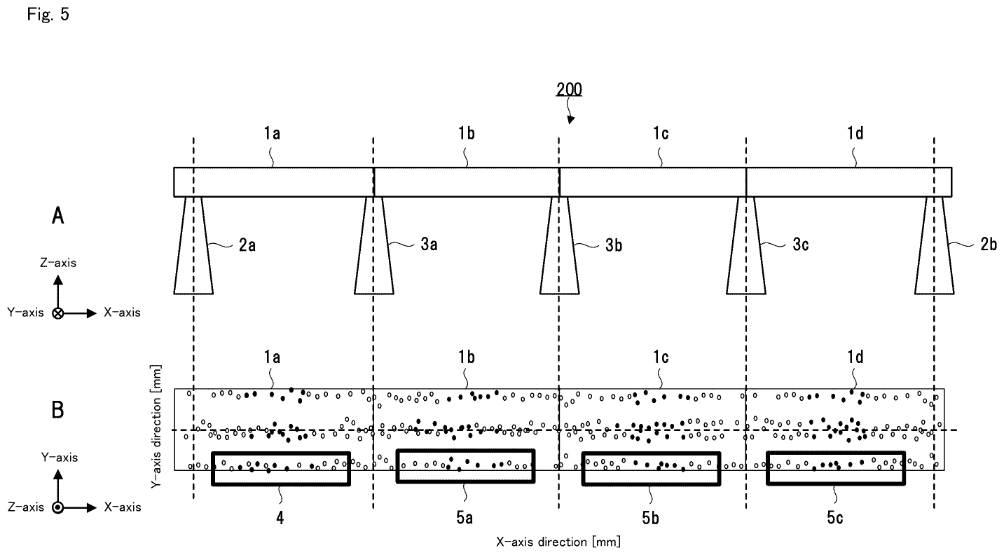

FIG. 5 is a diagram for describing relationships between the selected range and similar ranges, in the method (1). A in FIG. 5 is a side view illustrating the structure of the bridge 200. In the example in FIG. 5, the structure of the bridge 200 is illustrated using the superstructures 1a, 1b, 1c, and 1d, the abutments 2a and 2b, and the bridge piers 3a, 3b, and 3c, for the sake of description.

In the example in FIG. 5, different ranges 5a, 5b, and 5c are shown as ranges that have structures similar to the structure of the range 4 of the bridge 200, and are different from the range 4 of the bridge 200. In the method (1), the ranges 5 set by the setting unit 14 are ranges 5a, 5b, and 5c.

The calculation unit 12 calculates an index representing the correlation coefficient based on displacement information regarding the range 4 in a preset period and environmental information indicating the state of a surrounding environment of the bridge 200.

Also, when there are a plurality of preset periods, the calculation unit 12 calculates an index in the range 4 for each of the periods.

Moreover, the calculation unit 12 calculates indices representing correlation coefficients based on pieces of displacement information regarding the ranges 5a, 5b, and 5c and environmental information indicating the state of a surrounding environment of the bridge 200.

A case where the environmental information indicates a temperature will be described.

The calculation unit 12 first acquires pieces of displacement information regarding a plurality of measurement points included in the selected range 4. Also, the calculation unit 12 acquires a temperature at the reference time t0 and temperatures at the respective times tn included in the preset period.

Next, the calculation unit 12 calculates temperature differences ksn (=kn−k0: n=1, 2, 3, . . . ) between the temperature k0 at the reference time t0 and the temperatures kn (n=1, 2, 3, . . . ) at the respective times tn.

Next, the calculation unit 12 calculates a correlation coefficient using a plurality of pieces of displacement information regarding the plurality of measurement points included in the range 4 at respective times tn and the temperature differences ksn at the respective times tn. The correlation coefficient is a numerical value, a level, or the like that represents the degree of relationship between the displacement amount and the temperature difference, for example.

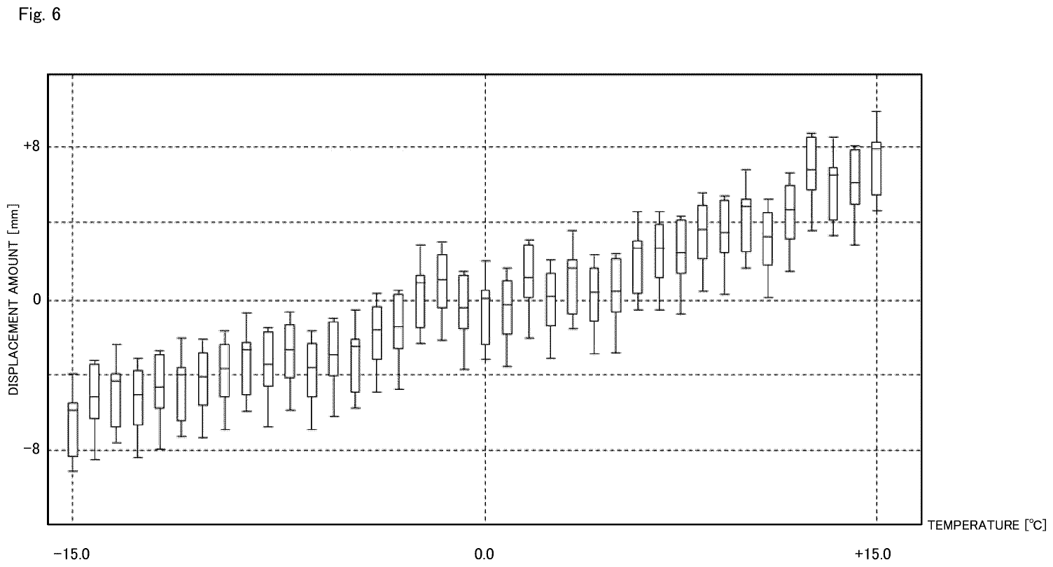

FIG. 6 is a box-and-whisker plot illustrating the correlation between the displacement amount and the temperature difference. The example in FIG. 6 shows a correlation between pieces of displacement information regarding the plurality of measurement points included in the range 4 at respective times tn and the temperature differences ksn at the respective times tn. The example in FIG. 6 shows a positive correlation.

Next, the calculation unit 12 acquires pieces of displacement information regarding a plurality of measurement points included in the range 5a, 5b, or 5c, for each of the ranges 5a, 5b, and 5c. Also, the calculation unit 12 acquires the temperature at the reference time t0 and temperatures at respective times tn, for each of the ranges 5a, 5b, and 5c.

Next, the calculation unit 12 calculates a correlation coefficient using the pieces of displacement information regarding the plurality of measurement points included in the range 5a at the respective times tn and the temperature differences at the respective times tn. The calculation unit 12 calculates a correlation coefficient using the pieces of displacement information regarding the plurality of measurement points included in the range 5b at the respective times tn and the temperature differences at the respective times tn. The calculation unit 12 calculates a correlation coefficient using the pieces of displacement information regarding the plurality of measurement points included in the range 5c at the respective times tn and the temperature differences at the respective times tn.

The generation unit 13 calculates statistical values (e.g., average value, variance value, and the like) using the correlation coefficients corresponding to the ranges 5a, 5b, and 5c, and generates a determination condition using the calculated statistical values.

The determination condition is favorably a condition in which an upper limit and a lower limit of a value range that a normal correlation coefficient may take are set using an average value and a standard deviation of the correlation coefficients, for example, and if a correlation coefficient is outside the value range, it is regarded as abnormal. For example, the upper limit and lower limit of the value range of the correlation coefficient may be set as “average value±1.5×standard deviation”, for example. Note that the determination condition is not limited to the aforementioned example.

The evaluation unit 15 evaluates the soundness of the range 4 based on the correlation coefficient of the range 4 and the determination condition. Specifically, if the correlation coefficient of the range 4 satisfies the determination condition, the evaluation unit 15 determines that the range 4 of the bridge 200 is normal. If the correlation coefficient of the range 4 does not satisfy the determination condition, the evaluation unit 15 determines that the range 4 of the bridge 200 is abnormal.

The output information generation unit 16 generates output information for outputting the structure of the bridge 200, the range 4 of the bridge 200, the correlation coefficient of the range 4, the ranges 5a, 5b, and 5c of the bridge 200, the correlation coefficients of the respective ranges 5a, 5b, and 5c, and the like, which is to be output to the output device 30. Thereafter, the output information generation unit 16 outputs the output information to the output device 30.

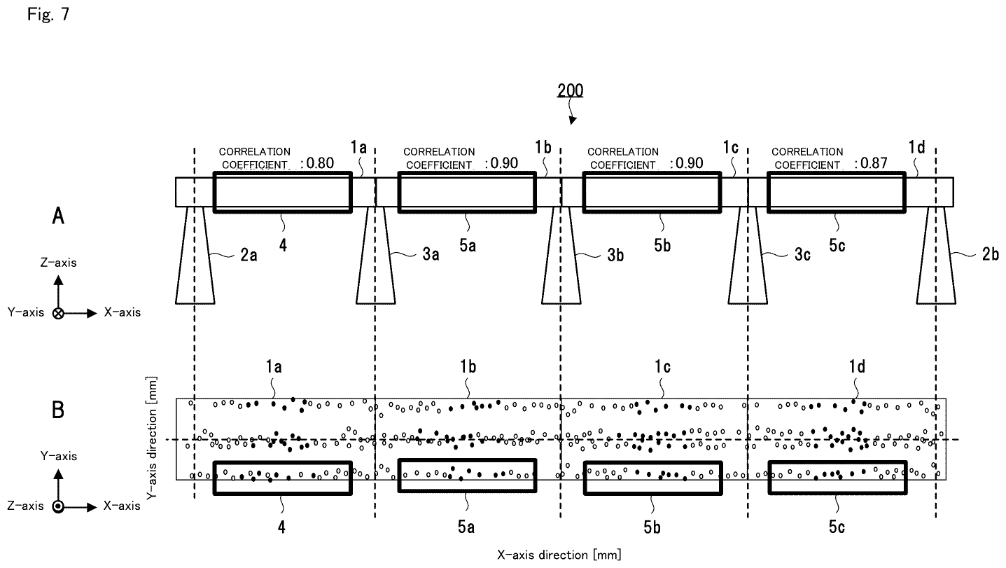

FIG. 7 is a diagram for describing an exemplary display in the method (1). In the example in FIG. 7, the ranges 4, 5a, 5b, and 5c and the correlation coefficients of the respective ranges are shown. Note that the determination condition and the result of soundness evaluation (normal or abnormal) may also be displayed.

The method (2) will be described in detail.

The setting unit 14 sets a bridge 200 to be subjected to soundness evaluation, a range 4, of the bridge 200, that is subjected to soundness evaluation, a reference time t0, a period (including a plurality of times) to be subjected to soundness evaluation, and ranges that have a structure similar to the structure of the range 4 and are included in a plurality of bridges similar to the bridge 200. Specifically, the setting unit 14 stores setting information indicating the settings described above in the storage device 20.

A user that performs soundness evaluation sets a bridge 200 to be evaluated, and a range 4. Also, the user that performs soundness evaluation sets a reference time t0, a period in which the soundness evaluation is to be performed, and different ranges that have a structure similar to the structure of the range 4 and are included in a plurality of bridges similar to the bridge 200 (hereinafter, may be simply denoted as different ranges 9).

The selection unit 11 selects, from pieces of displacement information indicating the displacement amounts of a plurality of measurement points included in a region including the bridge 200 and regions including the plurality of bridges similar to the bridge 200, pieces of displacement information regarding the range 4 and the different ranges 9 in a preset period, based on the range 4 and the different ranges 9 in the preset period.

Note that when a plurality of different periods are set, pieces of displacement information regarding the range 4 and the different ranges 9 are selected for each period. The plurality of different periods includes the period to be subjected to soundness evaluation (period to be evaluated), periods prior to the period to be evaluated, and the like, for example.

The ranges 9 that have a structure similar to the structure of the range 4 and are included in a plurality of bridges similar to the bridge 200 will be described. The range 4 and the different ranges 9 are set by a user based on the structure information.

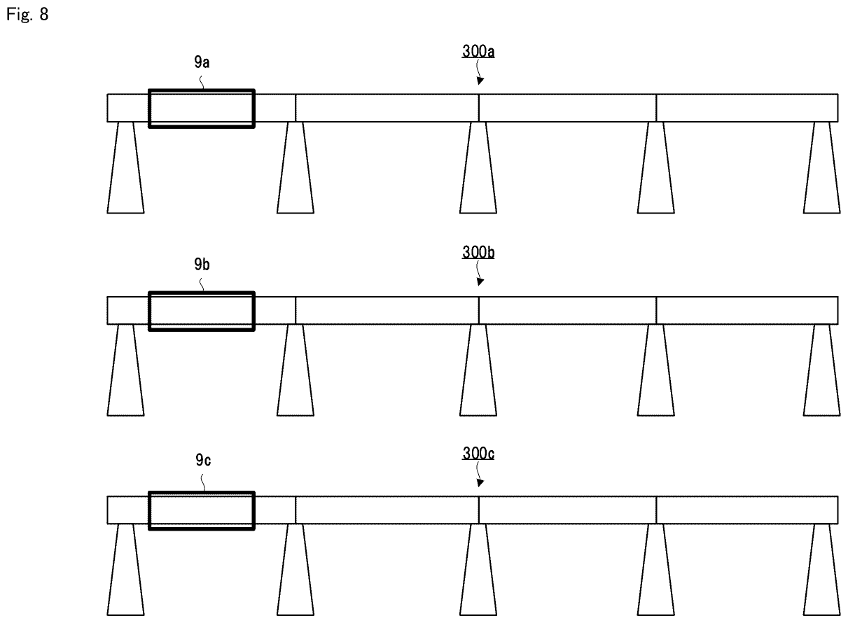

FIG. 8 is a diagram for describing a range of a similar bridge in the method (2). In the example in FIG. 8, bridges 300a, 300b, and 300c that are similar to the bridge 200, and ranges 9a, 9b, and 9c, of the respective bridges 300a, 300b, and 300c, that have a structure similar to the structure of the range 4 are shown. In the description below, the different ranges 9 set by the setting unit 14 are ranges 9a, 9b, and 9c.

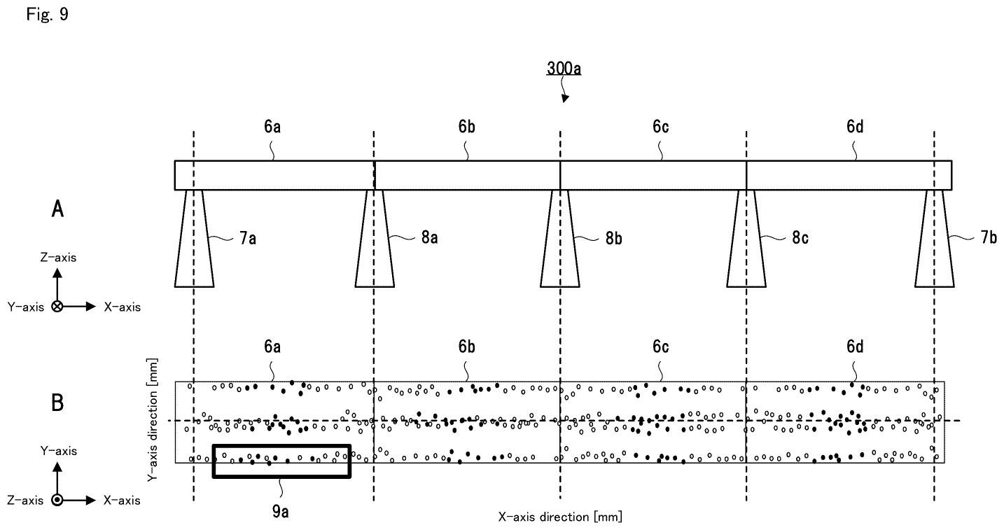

FIG. 9 is a diagram for describing the relationship between a similar bridge and measurement points in the method (2). A in FIG. 9 is a side view illustrating the structure of the bridge 300a similar to the bridge 200. In the example in FIG. 9, the structure of the bridge 300a is illustrated using superstructures 6a, 6b, 6c, and 6d, abutments 7a and 7b, and bridge piers 8a, 8b, and 8c, for the sake of description.

In the example in FIG. 9, the range 9a of the bridge 300a is shown as the range, of a bridge different from the bridge 200, that has a structure similar to the structure of the range 4 of the bridge 200.

The calculation unit 12 calculates an index representing a correlation coefficient based on displacement information regarding the range 4 in a preset period and environmental information indicating the state of a surrounding environment of the bridge 200.

Also, when there are a plurality of preset periods, the calculation unit 12 calculates indices in the range 4 for the respective periods.

Moreover, the calculation unit 12 calculates indices representing correlation coefficients based on pieces of displacement information regarding measurement points included in the respective ranges 9a, 9b, and 9c included in the respective bridges 300a, 300b, and 300c that are similar to the bridge 200 and pieces of environmental information indicating the state of surrounding environments of the respective bridges 300a, 300b, and 300c.

A case where the environmental information indicates a temperature will be described.

The calculation unit 12 first acquires pieces of displacement information regarding a plurality of measurement points included in the range 4. Also, the calculation unit 12 acquires a temperature of the bridge 200 at a reference time t0 and temperatures at respective times tn included in a preset period.

Next, the calculation unit 12 calculates temperature differences ksn (=kn−k0: n=1, 2, 3, . . . ) between the temperature k0 at the reference time t0 and the temperatures kn (n=1, 2, 3, . . . ) at the respective times tn.

Next, the calculation unit 12 calculates a correlation coefficient using a plurality of pieces of displacement information regarding the plurality of measurement points included in the range 4 at respective times tn and the temperature differences ksn at the respective times tn. The correlation coefficient is a numerical value, a level, or the like that represents the degree of relationship between the displacement amount and the temperature difference, for example.

Next, the calculation unit 12 acquires pieces of displacement information regarding a plurality of measurement points included in the range 9a, 9b, or 9c, for each of the ranges 9a, 9b, and 9c. Also, the calculation unit 12 acquires a temperature at a reference time t0 and temperatures at the respective times tn, for each of the bridges 300a, 300b, and 300c.

Next, the calculation unit 12 calculates a correlation coefficient using the pieces of displacement information regarding the plurality of measurement points included in the range 9a at the respective times tn and the temperature differences at the respective times tn. Also, the calculation unit 12 calculates a correlation coefficient using the pieces of displacement information regarding the plurality of measurement points included in the range 9b at the respective times tn and the temperature differences at the respective times tn. Moreover, the calculation unit 12 calculates a correlation coefficient using the pieces of displacement information regarding the plurality of measurement points included in the range 9c at the respective times tn and the temperature differences at the respective times tn.

The generation unit 13 calculates statistical values (e.g., average value, variance value, and the lie) using the correlation coefficients corresponding to the ranges 9a, 9b, and 9c, and generates a determination condition using the calculated statistical values.

The determination condition is favorably a condition in which an upper limit and a lower limit of a value range that a normal correlation coefficient may take are set using an average value and a standard deviation of the correlation coefficients, for example, and if a correlation coefficient is outside the value range, it is regarded as abnormal. For example, the upper limit and lower limit of the value range of the correlation coefficient may be set as “average value±1.5×standard deviation”, for example. Note that the determination condition is not limited to the aforementioned example.

The evaluation unit 15 evaluates the soundness of the range 4 based on the correlation coefficient of the range 4 and the determination condition. Specifically, if the correlation coefficient of the range 4 is inside the determination condition (set range), the evaluation unit 15 determines that the range 4 of the bridge 200 is normal. If the correlation coefficient of the range 4 is outside the determination condition (set range), the evaluation unit 15 determines that the range 4 of the bridge 200 is abnormal.

The output information generation unit 16 generates output information for outputting the structures of the bridges 200, 300a, 300b, and 300c, the range 4 of the bridge 200, the correlation coefficient of the range 4, the ranges 9a, 9b, and 9c of the respective bridges 300a, 300b, and 300c, the correlation coefficients of the respective ranges 9a, 9b, and 9c, and the like, which is to be output to the output device 30. Thereafter, the output information generation unit 16 outputs the output information to the output device 30.

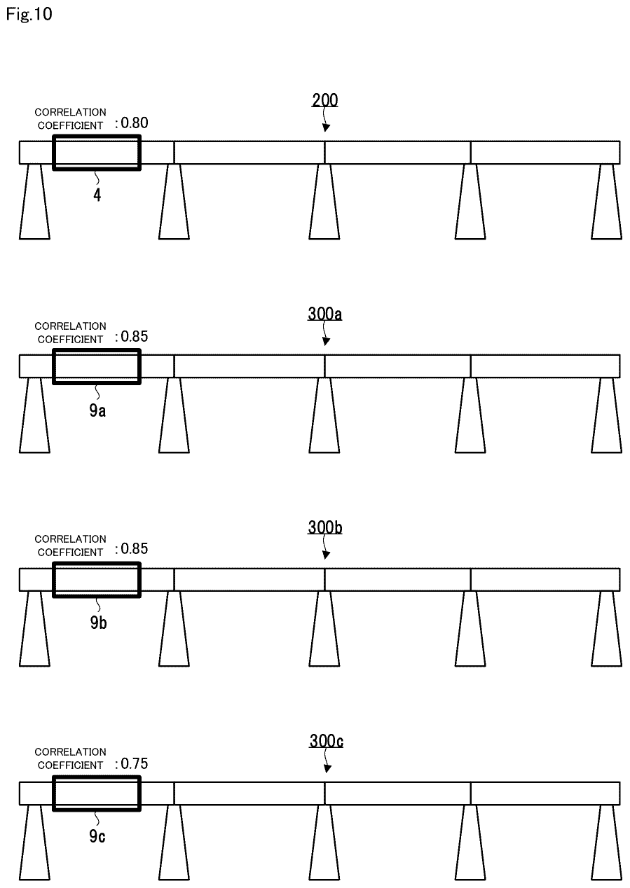

FIG. 10 is a diagram for describing an exemplary display in the method (2). In the example in FIG. 10, the ranges 4, 9a, 9b, and 9c and the correlation coefficients of the respective ranges are shown. Note that the determination condition and the result of soundness evaluation (normal or abnormal) may also be displayed.

The method (3) will be described in detail.

The setting unit 14 sets a bridge 200 to be subjected to soundness evaluation, a range 4, of the bridge 200 that is subjected to soundness evaluation, a reference time t0, and a plurality of different periods. Specifically, the setting unit 14 stores setting information indicating the settings described above in the storage device 20.

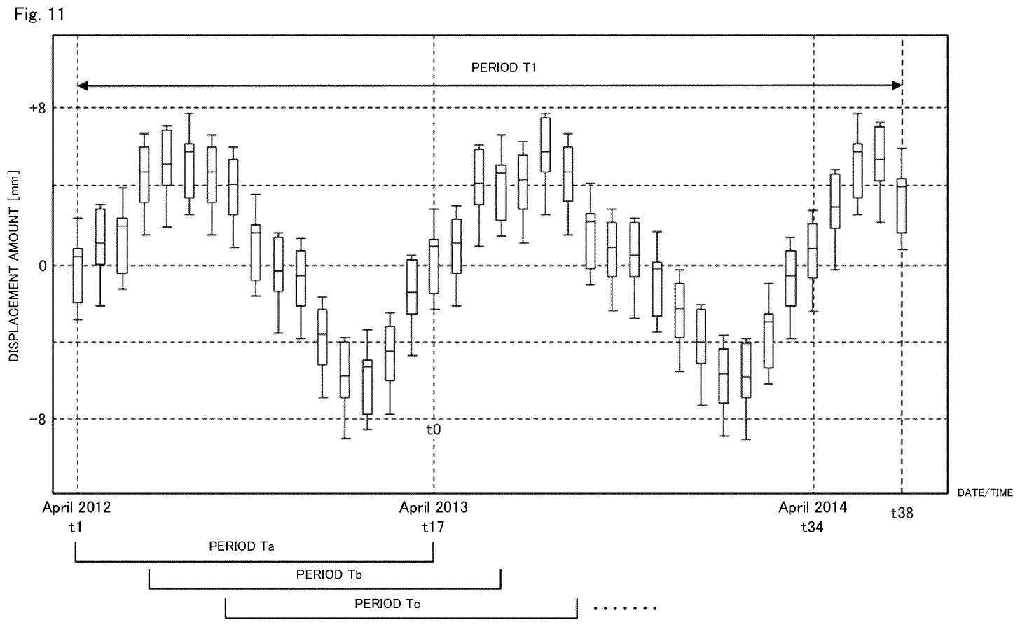

FIG. 11 is a diagram for describing the plurality of different periods in the method (3). In the example in FIG. 11, a plurality of one-year periods are set whose starting times are respectively shifted by three months, namely a period Ta (a plurality of times included in a period from April 2012 to April 2013), a period Tb (a plurality of times included in a period from July 2012 to July 2013), a period Tc (a plurality of times included in a period from October 2012 to October 2013), and so on.

The selection unit 11 selects pieces of displacement information regarding the range 4 of the bridge 200 for each of the plurality of preset different periods from pieces of displacement information, which were estimated at a plurality of times, that indicate displacement amounts of a plurality of measurement points included in a region including the bridge 200.

The calculation unit 12 calculates indices representing correlation coefficients based on the pieces of displacement information regarding the range 4 in the plurality of different periods Ta, Tb, Tc, and so on, and pieces of environmental information indicating the state of a surrounding environment of the bridge 200.

A case where the environmental information indicates a temperature will be described.

The calculation unit 53 first acquires pieces of displacement information regarding a plurality of measurement points included in the range 4 for respective times included in the period Ta, Tb, Tc, or the like, for each of the periods Ta, Tb, Tc, and so on. Also, the calculation unit 53 acquires a temperature at the reference time t0 and temperatures at respective times included in the periods Ta, Tb, Tc, and so on.

Next, the calculation unit 53 calculates temperature difference ksn (=kn−k0: n=1, 2, 3, . . . ) between a temperature k0 at the reference time t0 and respective temperatures kn (n=1, 2, 3, . . . ) at respective times tn.

Next, the calculation unit 53 calculates, for each of the periods Ta, Tb, Tc, and so on, a correlation coefficient using the pieces of displacement information regarding the plurality of measurement points included in the range 4 at respective times included in the period Ta, Tb, Tc, or the like and the temperature differences ksn at the respective times. The correlation coefficient is a numerical value, a level, or the like that represents the degree of relationship between the displacement amount and the temperature difference, for example.

The generation unit 13 calculates statistical values (e.g., average value, variance value, and the lie) using the respective correlation coefficients corresponding to the plurality of different periods Ta, Tb, Tc, and so on and generates a determination condition using the calculated statistical values. The determination condition is favorably a condition in which an upper limit and a lower limit of a value range that a normal correlation coefficient may take are set using an average value and a standard deviation of the correlation coefficients, for example, and if a correlation coefficient is outside the value range, it is regarded as abnormal. For example, the upper limit and lower limit of the value range of the correlation coefficient may be set as “average value±1.5×standard deviation”, for example. Note that the determination condition is not limited to the aforementioned example.

The evaluation unit 15 evaluates the soundness of the range 4 based on the correlation coefficients corresponding to the plurality of different periods Ta, Tb, Tc, and so on and the determination condition. Specifically, if the correlation coefficient of the range 4 satisfies the determination condition, the evaluation unit 15 determines that the range 4 of the bridge 200 is normal. If the correlation coefficient of the range 4 does not satisfy the determination condition, the evaluation unit 15 determines that the range 4 of the bridge 200 is abnormal.

The output information generation unit 16 generates output information for outputting the structure of the bridge 200, the range 4 of the bridge 200, the correlation coefficients of the range 4 in the past periods, and the like, which is to be output to the output device 30. Thereafter, the output information generation unit 16 outputs the output information to the output device 30.

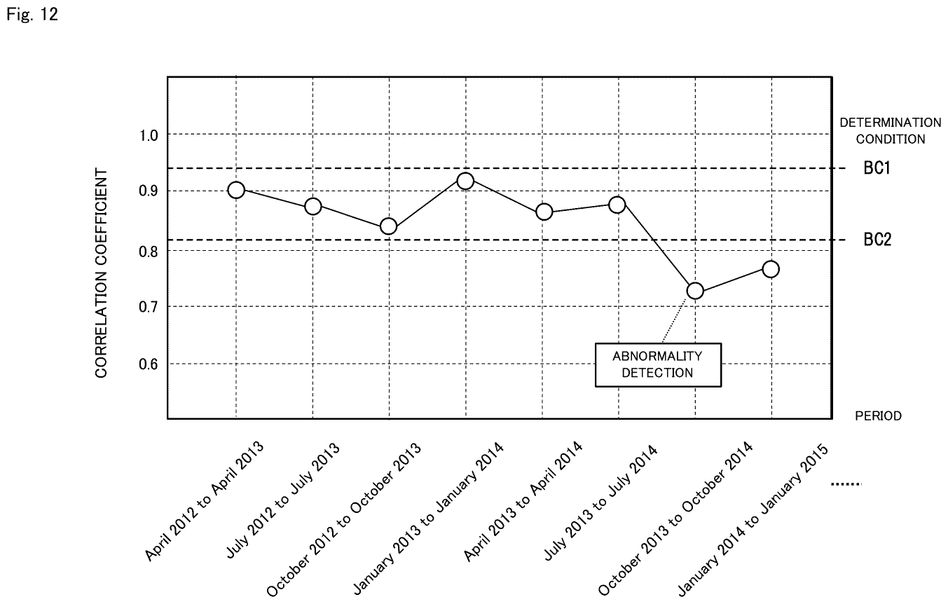

FIG. 12 is a diagram for describing an exemplary display in the method (3). In the example in FIG. 12, the correlation coefficients of the range 4 in the periods Ta, Tb, Tc, and so on are shown in time series. Moreover, determination conditions BC1 and BC2 are shown in FIG. 12, and BC1 and BC2 respectively indicate an upper limit and lower limit of values that a normal correlation coefficient may take. Also, the correlation coefficient in a period from October 2013 to October 2014 is outside the determination condition (set range), and therefore it is determined 25 that the range 4 of the bridge 200 is abnormal in the period from October 2013 to October 2014.

An application example 1 of the example embodiment will be described.

The soundness evaluation apparatus 10 that evaluates soundness by generating determination conditions different from each other based on the methods (1), (2), and (3) has been described. The methods (1), (2), and (3) are characterized by a fact that the ranges (target ranges) for which the index to be used for generating the determination condition is calculated are different from each other. In the method (1), the range is selected from the bridge to be evaluated. In the method (2), the range is selected from a different bridge having a structure similar to the bridge to be evaluated. In the method (3), pieces of displacement information in a plurality of past periods regarding the range of the bridge to be evaluated are selected.

Note that when generating a determination condition, the determination condition may also be generated collectively using indices of the target ranges that are used in the methods (1), (2), and (3). That is, a configuration may also be adopted in which ranges are respectively selected from the bridge to be evaluated and a different bridge having a structure similar to the bridge to be evaluated, pieces of displacement information regarding these ranges in a plurality of past periods are selected, indices are calculated using the selected pieces of displacement information, and with this, the determination condition is generated.

An application example 2 of the example embodiment will be described.

In the description above, the soundness evaluation apparatus 10 has been described in which the calculation unit 12 uses displacement information regarding a preset range in a preset period as is, when calculating the index, in any of the methods (1), (2), and (3). However, the calculation unit 12 may also use corrected displacement information obtained by correcting the displacement information by approximation using a mathematical model.

For example, assume that the displacement information can be ideally expressed by some mathematical model such as a linear equation, a piecewise linear function, a polynomial, an exponential function, or a trigonometric function, and a function expression that is closest to the displacement information is obtained using a least squares method or the like. Note that the corrected displacement information may also be obtained by correcting the displacement information by approximation using the function expression. The method of approximation using a mathematical model is not limited to the method described above, and a mathematical model using machine learning may also be used.

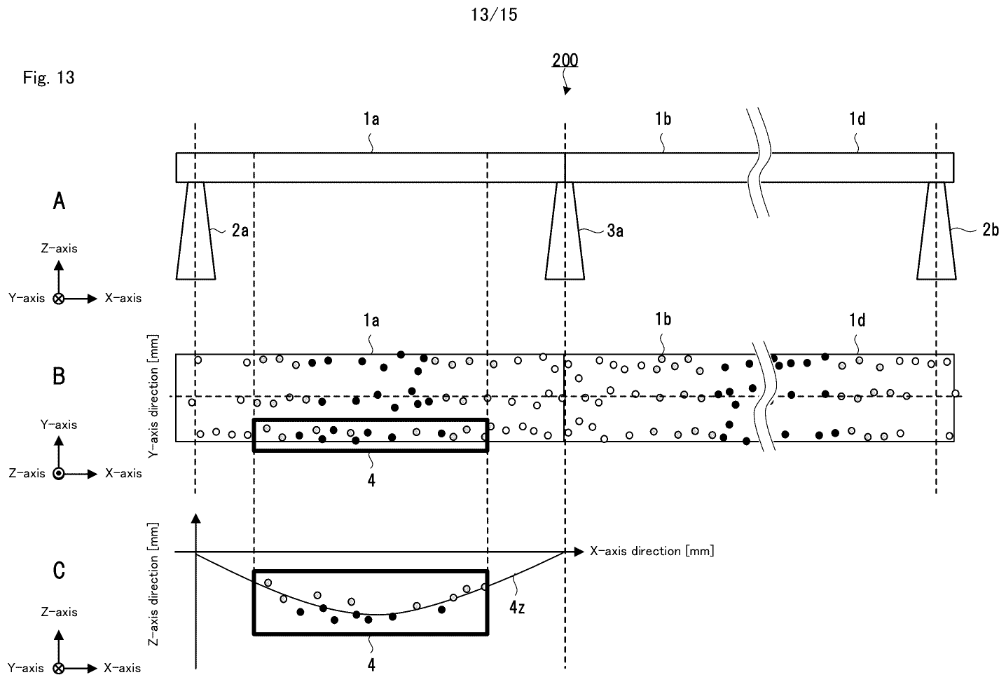

An example of a function approximation will be described with reference to FIG. 13, as a specific example of approximation by a mathematical model. FIG. 13 is a diagram for describing a specific example of the function approximation.

A in FIG. 13 is a side view illustrating the structure of the bridge 200 subjected to soundness evaluation. B in FIG. 13 is a top view illustrating a plurality of measurement points (e: circle) when the bridge 200 was measured with SAR. C in FIG. 13 is a diagram illustrating an example of the function approximation for displacement information at a certain time regarding the measurement points included in the range 4.

C in FIG. 13 is illustrated focusing on a case where the pieces of displacement information regarding the measurement points included in the range 4 include only Z-axis direction components (vertical direction components), or a case where other components are negligibly small and the Z-axis direction component is regarded as dominant. The measurement points in C in FIG. 13 represent pieces of displacement information regarding the measurement points in the range 4 at a certain time tn. The contrasting density of a circle of a measurement point represents the size of displacement indicated by the displacement information. A curved line 4z in C in FIG. 13 is a curved line obtained by performing function approximation on the circles.

An example of a favorable method when performing function approximation on the measurement points is a method that uses a fact that the static displacement (bend) in a Z-axis direction (vertical direction) of a simple supported beam at a position in an X-axis direction (longitudinal direction) is represented by a polynomial of the position.

In this method, it is assumed that the displacement information regarding the range 4 at any time tn can be expressed by a polynomial G(X, tn) in which the position of the bridge 200 in the X-axis direction is a variable X, and undetermined coefficients αtn (tn indicates each time tn in a selected period) and Cj included in the polynomial G(X, tn)=αtn×(Fj{Cj×X\hat{ }j}) are obtained using a non-linear least squares method.

X\hat{ }j represents the j-th power of X. x is a product symbol. Σj{Aj} is a symbol for calculating a sum of Aj in a value range that j (=0, 1, 2, 3, 4, . . . ) may take. αtn is an undetermined coefficient that depends solely on time tn, and does not depend on the variable X. Cj are undetermined coefficients that depend neither on time tn nor on the variable X, and are undetermined coefficients that are held in common in all pieces of displacement information regarding the range 4 at any time tn in the selected period.

The number of undetermined coefficients is represented by “the total number of times tn”+5, and the number of pieces of displacement information to be used in the non-linear least squares method is represented by “the number of measurement points” x“the total number of times tn”, which is overwhelmingly larger than the number of undetermined coefficients, and therefore the undetermined coefficients can be obtained.

A value derived by correcting displacement information at any measurement point included in the range 4 of the bridge 200 can be calculated by using the obtained polynomial G(X, tn). The displacement information regarding a measurement point can be corrected by substituting the position of the measurement point in the X-axis direction into the polynomial G(X, tn), and the obtained value is the corrected displacement information. Similarly to the concept of the function approximation and correction regarding the range 4 shown in C in FIG. 13, the calculation unit 12 may also perform function approximation and correction with respect to pieces of displacement information regarding measurement points included in the ranges 5 and the ranges 9.

An application example 3 of the example embodiment will be described.

In the application example 3, the calculation unit 12 may also calculate an index representing the correlation between the coefficient αtn and environmental information using the coefficient αtn of the polynomial G(X, tn) obtained in the application example 2 instead of the displacement information. The coefficient αtn is a value representing the features of all pieces of the displacement information in the range 4 at time tn in the selected period. Therefore, it is desirable in that the coefficient αtn is not likely to be influenced by noise in the displacement information and the environmental information.

In addition, the calculation amount can be reduced when the correlation coefficient between the coefficient can and the environmental information is calculated as an index relative to the case where the correlation coefficient between the corrected displacement information obtained by correcting the displacement information using the polynomial G(X, tn) and the environmental information is calculated as an index.

### [Apparatus Operations]

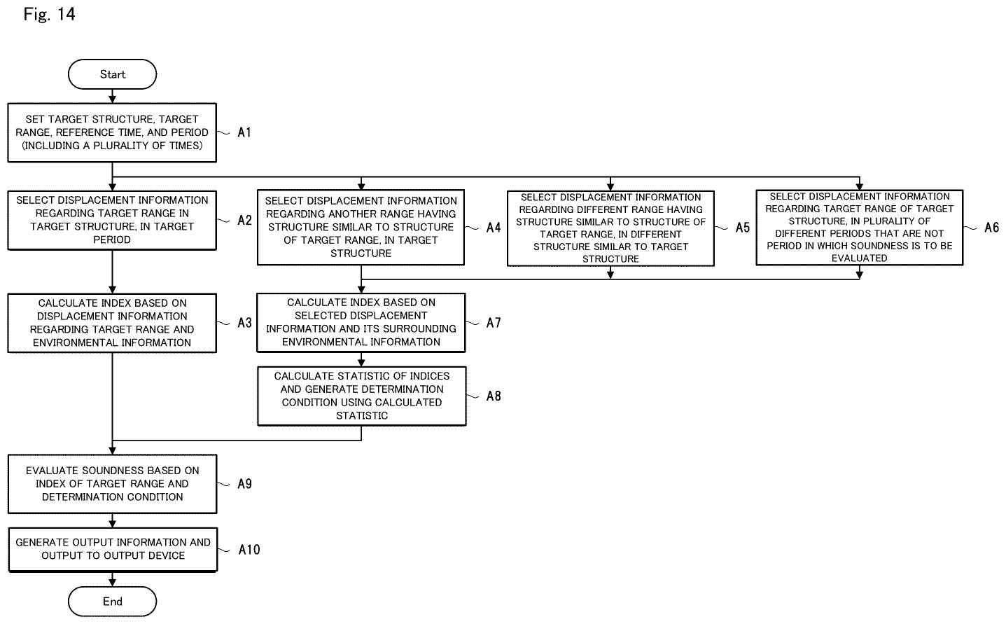

Next, operations of the soundness evaluation apparatus in the example embodiment will be described using FIG. 14. FIG. 14 is a diagram illustrating an example of the operations of the soundness evaluation apparatus of the example embodiment. In the following description, the diagrams are referred to as appropriate. Furthermore, in the example embodiment, a soundness evaluation method is implemented by causing the soundness evaluation apparatus to operate. Accordingly, the following description of the operations of the soundness evaluation apparatus replaces the description of the soundness evaluation method in the example embodiment.

Note that in the following description, it is assumed that the calculation unit 12 calculates an index using the displacement information as is. Note that the calculation unit 12 may calculate an index, when calculating the index, using the displacement information as is, using corrected displacement information obtained by correcting the displacement information using function approximation, or using a coefficient obtained by function approximation. The specific function approximation and correction method are as described in the application examples 2 and 3 of the example embodiment.

As shown in FIG. 14, first, the setting unit 14 first sets a bridge 200 (structural object) to be subjected to soundness evaluation (target structure), a range 4, of the bridge 200, that is subjected to soundness evaluation (target range), a reference time t0, and at least one period (including a plurality of times) subjected to soundness evaluation (step A1). Moreover, in step A1, the setting unit 14 may also set any of the pieces of information 1, 2, and 3 shown next, as the setting information.

Ranges 5 that are different from the range 4 of the bridge 200 and have a structure similar to the structure of the range 4 are set as the information 1. The ranges 5 include the ranges 5a, 5b, and 5c shown in FIG. 5, for example.

Ranges 9 that have a structure similar to the structure of the range 4 and are included in a plurality of bridges similar to the bridge 200 are set as the information 2. The ranges 9 includes the ranges 9a, 9b, and 9c shown in FIG. 8.

A plurality of different periods Ta, Tb, Tc, and so on that are not the period to be subjected to soundness evaluation are set as the information 3.

Note that the setting unit 14 stores the aforementioned pieces of setting information in the storage device 20.

Next, the selection unit 11 selects pieces of displacement information regarding the range 4 in a preset period, from pieces of displacement information indicating displacement amounts of a plurality of measurement points included in a region including the bridge 200, based on the preset period and the range 4 (step A2).

Next, the calculation unit 12 calculates an index using the pieces of displacement information regarding the selected range 4 and environmental information (step A3). The index calculated by the calculation unit 12 represents correlation between the displacement information and the environmental information. For example, the index is a correlation coefficient between the displacement information and the environmental information.

Next, when the setting unit 14 sets (information 1), the selection unit 11 selects pieces of displacement information regarding the ranges 5 (step A4).

Alternatively, when the setting unit 14 sets (information 2), the selection unit 11 selects pieces of displacement information regarding the ranges 9 (step A5).

Alternatively, when the setting unit 14 sets (information 3), the selection unit 11 selects pieces of displacement information regarding the range 4 in a plurality of different periods Ta, Tb, Tc, and so on that are not the period to be subjected to soundness evaluation (step A6).

Next, the calculation unit 12 calculates an index using pieces of displacement information selected in any of steps A4, A5, and A6 and surrounding environmental information regarding the pieces of displacement information (step A7). For example, the index may be a correlation coefficient between the displacement information and the environmental information.

Next, the generation unit 13 generates a determination condition using the index calculated in step A7 (step A8). The determination condition is favorably a condition in which an upper limit and a lower limit of a value range that a normal index may take are set using an average value and a standard deviation of the index, and if the index is out of the value range, it is regarded as abnormal, for example. For example, the upper limit and lower limit of the index value range may be set as “average value±1.5×standard deviation”. Note that the determination condition is not limited to the example described above.

Next, the evaluation unit 15 evaluates the soundness based on the index of the selected range 4 and the determination condition (step A9).

Next, the output information generation unit 16 generates output information for outputting to the output device 30, and outputs the output information to the output device 30 (step A10).

### Effects in Example Embodiment

According to the example embodiment, the determination condition used for soundness evaluation can be automatically generated. Also, as another effect, as a result of using information regarding another range having a structure similar to the structure of a target range of a structural object to be evaluated, an accurate evaluation criterion can be generated.

Also, as another effect, as a result of using a plurality pieces of displacement information in a plurality of different periods and environmental information, an accurate evaluation criterion can be generated.

Also, as another effect, as a result of correcting the displacement information, the soundness can be evaluated while reducing the influence of noise components included in the displacement information and the environmental information.

### [Program]

The program according to the embodiment may be a program that causes a computer to execute steps A1 to A10 shown in FIG. 14. By installing this program in a computer and executing the program, the soundness evaluation apparatus and the soundness evaluation method according to the example embodiment can be realized. In this case, the processor of the computer performs processing to function as the setting unit 14, the selection unit 11, the calculation unit 12, the generation unit 13, the evaluation unit 15, and the output information generation unit 16.

Also, the program according to the embodiment may be executed by a computer system constructed by a plurality of computers. In this case, for example, each computer may function as any of the setting unit 14, the selection unit 11, the calculation unit 12, the generation unit 13, the evaluation unit 15, and the output information generation unit 16.

### [Physical Configuration]

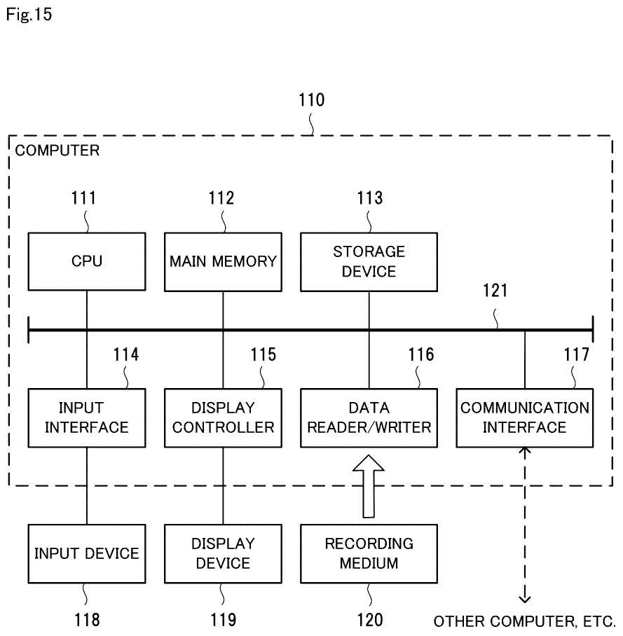

Here, a computer that realizes the soundness evaluation apparatus by executing the program according to an example embodiment will be described with reference to FIG. 15. FIG. 15 is a diagram for describing an example of a computer that realizes the soundness evaluation apparatus in the example embodiment.

As shown in FIG. 15, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU (Graphics Processing Unit) or an FPGA (Field-Programmable Gate Array) in addition to the CPU 111 or in place of the CPU 111.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory). Also, the program according to this example embodiment is provided in a state being stored in a computer-readable recording medium 120. Note that the program according to this example embodiment may be distributed on the Internet, which is connected through the communications interface 117. Note that the computer-readable recording medium 120 is a non-volatile recording medium.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

Also, instead of a computer in which a program is installed, the soundness evaluation apparatus according to this example embodiment can also be realized by using hardware corresponding to each unit. Furthermore, a portion of the soundness evaluation apparatus 10 may be realized by a program, and the remaining portion realized by hardware.

Although the present invention of this application has been described with reference to exemplary embodiments, the present invention of this application is not limited to the above exemplary embodiments. Within the scope of the present invention of this application, various changes that can be understood by those skilled in the art can be made to the configuration and details of the present invention of this application.

### INDUSTRIAL APPLICABILITY

As described above, the determination conditions for evaluating the soundness are automatically generated, and the soundness can be evaluated. In addition, it is useful in a field where the soundness of a structure needs to be evaluated.

### REFERENCE SIGNS LIST

200, 300a, 300b, 300c Bridge
   1a, 1b, 1c, 1d, 6a, 6b, 6c, 6d Superstructure
   2a, 2b, 7a, 7b Abutment
   3a, 3b, 3c, 8a, 8b, 8c Bridge pier
   4 Range set in the bridge 200
   5, 5a, 5b, 5c Different range that has a structure similar to the structure of the range 4
   9, 9a, 9b, 9c Different ranges of different bridge that has a structure similar to the structure of the range 4
   4z Function-approximated curve
10 Soundness evaluation apparatus
11 Selection unit
12 Calculation unit
13 Generation unit
14 Setting unit
15 Evaluation unit
16 Output information generation unit
20 Storage device
30 Output device
100, 500 System
110 Computer
111 CPU
112 Main memory
113 Storage device
114 Input interface
115 Display controller
116 Data reader/writer
117 Communications interface
118 Input device
119 Display device
120 Recording medium
121 Bus

What is claimed is:

1. A soundness evaluation apparatus comprising:
at least one memory storing instructions; and
at least one processor configured to execute the instructions to:
select, from pieces of displacement information indicating displacement amounts of a plurality of measurement points included in a region including a structural object, displacement information regarding a range set in the structural object, based on a preset period and the range;
calculate an index representing a correlation based on the displacement information regarding the range in the period and environmental information indicating a state of an environment surrounding the range; and
generate determination condition to be used for evaluating soundness of the structural object based on a plurality of the calculated indices.

2. The soundness evaluation apparatus according to claim 1,
wherein the one or more processors further:
calculates a first index in a first range set in a first structural object and a second index in each second range, in the first structural object, that has a structure similar to a structure of the first range,
calculates a statistical value based on a plurality of the second indices, and generates the determination condition based on the calculated statistical value, and
the soundness evaluation apparatus further comprises
evaluate soundness of the first range based on the first index and the determination condition.

3. The soundness evaluation apparatus according to claim 2,
wherein the one or more processors further:
calculates a third index in the first range in a second period prior to a first period to be subjected to soundness evaluation, and
calculates the statistical value based on the third index and the plurality of second indices, and generates the determination condition based on the calculated statistical value.

4. The soundness evaluation apparatus according to claim 1,
wherein the one or more processors further:
calculates a first index in a first range set in a first structural object, and calculates fourth indices in respective third ranges, in a plurality of second structural objects similar to the first structural object, that have a structure similar to that of the first range,
generates the determination condition based on a plurality of the fourth indices, and
the soundness evaluation apparatus further comprises
evaluate soundness of the first range based on the first index and the determination condition.

5. The soundness evaluation apparatus according to claim 4,
wherein the one or more processors further:
calculates a fifth index in the first range in a second period prior to a first period to be subjected to soundness evaluation, and
calculates a statistical value based on the fourth indices and a plurality of the fifth indices, and generates the determination condition based on the calculated statistical value.

6. The soundness evaluation apparatus according to claim 2, wherein the calculation means creates a mathematical model representing displacement information selected by the selection means regarding the range in the period, and calculates the first index using the mathematical model.

7. A soundness evaluation method comprising:
selecting, from pieces of displacement information indicating displacement amounts of a plurality of measurement points included in a region including a structural object, displacement information regarding a range set in the structural object, based on a preset period and the range;
calculating an index representing a correlation based on the displacement information regarding the range in the period and environmental information indicating a state of an environment surrounding the range; and
generating a determination condition to be used for evaluating soundness of the structural object based on a plurality of the calculated indices.

8. A non-transitory computer-readable recording medium having recorded thereon a program for causing a computer to carry out:
selecting, from pieces of displacement information indicating displacement amounts of a plurality of measurement points included in a region including a structural object, displacement information regarding a range set in the structural object, based on a preset period and the range;
calculating an index representing a correlation based on the displacement information regarding the range in the period and environmental information indicating a state of an environment surrounding the range; and
generating a determination condition to be used for evaluating soundness of the structural object based on a plurality of the calculated indices.
